(19) United States
(12) Patent Application Publication
(10) Pub. No.: US 2013/0161533 A1
(43) Pub. Date: Jun. 27, 2013

(54) BIOCHIP ANALYSIS DEVICE

(71) Applicants: Dong-Ho SHIN, Daejeon (KR); Moon Youn Jung, Daejeon (KR)

(72) Inventors: Dong-Ho SHIN, Daejeon (KR); Moon Youn Jung, Daejeon (KR)

(73) Assignee: Electronics and Telecommunications Research Institute, Daejeon (KR)

(21) Appl. No.: 13/615,073

(22) Filed: Sep. 13, 2012

(30) Foreign Application Priority Data
Dec. 23, 2011 (JP) 10-2011-0141154

(51) Int. Cl. G02F 1/01; G01N 21/64

(52) U.S. Cl. 250/458.1; 359/245; 250/206

(57) ABSTRACT

Disclosed is a biochip analysis device which includes first and second spatial light modulators; and a spatial light modulation driver configured to drive the first and second spatial light modulators, wherein the first spatial light modulator varies a wavelength of light to be irradiated to a biochip in response to a control of the spatial light modulation driver and the spatial light modulator passes a fluorescence signal selected from fluorescence signals generated by the biochip in response to a control of the spatial light modulation driver.

### CROSS-REFERENCE TO RELATED APPLICATIONS

A claim for priority under 35 U.S.C. §119 is made to Korean Patent Application No. 10-2011-0141154 filed Dec. 23, 2011, in the Korean Intellectual Property Office, the entire contents of which are hereby incorporated by reference.

### BACKGROUND

The inventive concepts described herein relate to a biochip analysis device.

A biochip may be a chip which is made using various ingredients in a body of the living organism such as DNA, protein, and the like. Like a semiconductor chip formed by integrating fine electronic circuits on a silicon substrate, the biochip may be formed by integrating many bio substances on a glass or plastic substrate.

The biochip may include a DNA chip including various types of DNA pieces, a protein chip including various antigens or antibodies respectively joined with various proteins, a bionic sensor chip including bionic substances, a neuron network chip using an information processing method of a neuron cell, and the like.

The biochip may be miniaturized as it maintains the accuracy. Since using a chemical reaction, the biochip may not need electricity and generate heat. Thanks to these advantages, the biochip may be widely used for the human genome project, a gene expression analysis for testing a genetic disease, fine chemistry, bioprocess industry field, and the like.

To analyze a property of the biochip, a wavelength of light radiated to the biochip must be adjusted to be suitable for an absorption band of a fluorescent substance of the biochip. Mechanical devices such as spectroscope, filter, and the like may be used to adjust a wavelength of light radiated to the biochip. The mechanical devices may make it difficult to miniaturize a biochip analysis device.

### SUMMARY

Example embodiments of the inventive concept provide a biochip analysis device which comprises first and second spatial light modulators; and a spatial light modulation driver configured to drive the first and second spatial light modulators, wherein the first spatial light modulator varies a wavelength of light to be irradiated to a biochip in response to a control of the spatial light modulation driver and the spatial light modulator passes a fluorescence signal selected from fluorescence signals generated by the biochip in response to a control of the spatial light modulation driver.

In example embodiments, the first spatial light modulator comprises a liquid crystal; a color filter formed on the liquid crystal; and a thin film transistor controlling light to be provided to the color filter, wherein the first spatial light modulator varies a wavelength of light to be irradiated to the biochip by turning off or on the thin film transistor.

In example embodiments, the color filter has an array structure in which one pixel is formed of a red channel, a green channel, and a blue channel.

In example embodiments, the first spatial light modulator varies a wavelength of light to be irradiated to the biochip by combining light passing through the red, green, and blue channels.

In example embodiments, the first spatial light modulator further comprises a light source white light, the light source, the liquid crystal, the color filter, and the thin film transistor being formed of one module.

In example embodiments, the color filter is formed of a pigment or dielectric thin film.

In example embodiments, the first spatial light modulator varies a wavelength of light to be irradiated to the biochip so as to correspond to an absorption wavelength band of a fluorescence substance of the biochip.

In example embodiments, the second spatial light modulator comprises a liquid crystal; a color filter formed on the liquid crystal; and a thin film transistor controlling light to be provided to the color filter, wherein the second spatial light modulator passes through a fluorescence signal of a selected wavelength from among fluorescence signals generated from the biochip by turning off or on the thin film transistor.

In example embodiments, the liquid crystal, the color filter, and the thin film transistor is formed of one module.

In example embodiments, the biochip analysis device further comprises a sensor receiving a fluorescence signal passing through the second spatial light modulator; and a central processing unit analyzing a fluorescence signal reaching the sensor to judge a property of the biochip.

In example embodiments, the first spatial light modulator irradiates light to the biochip with a predetermined tilt angle and the second spatial light modulator passes through a fluorescence signal, having a direction perpendicular to the biochip, from among fluorescence signals generated form the biochip.

Example embodiments of the inventive concept also provide a biochip analysis device which comprises a spatial light modulator; and a spatial light modulation driver driving the spatial light modulator, wherein the spatial light modulator analyzes an optical absorption property of the biochip by varying a wavelength of light to be irradiated to the biochip in response to a control of the spatial light modulation driver.

In example embodiments, the spatial light modulator includes a plate receiving the biochip, the plate being formed to have an array structure which includes a plurality of wells receiving a plurality of biochip samples, respectively.

In example embodiments, the spatial light modulator further includes a color filter, the plurality of wells corresponding to channels or pixels of the color filter, respectively.

In example embodiments, the spatial light modulator further comprises a liquid crystal; a color filter formed on the liquid crystal; and a thin film transistor controlling light to be provided to the color filter, wherein the color filter has an array structure in which one pixel is formed of a red channel, a green channel, and a blue channel and the thin film transistor varies a wavelength of light to be irradiated to the biochip by turning on or off sub transistors corresponding to the red, green, and blue channels, respectively.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a biochip analysis device according to an embodiment of the inventive concept.

FIGS. 2 and 3 are diagrams schematically illustrating a first spatial light modulator 110 in FIG. 1.

FIGS. 4 and 5 are diagrams schematically illustrating a biochip analysis device according to another embodiment of the inventive concept.

FIG. 6 is a diagram schematically illustrating a biochip analysis device according to still another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

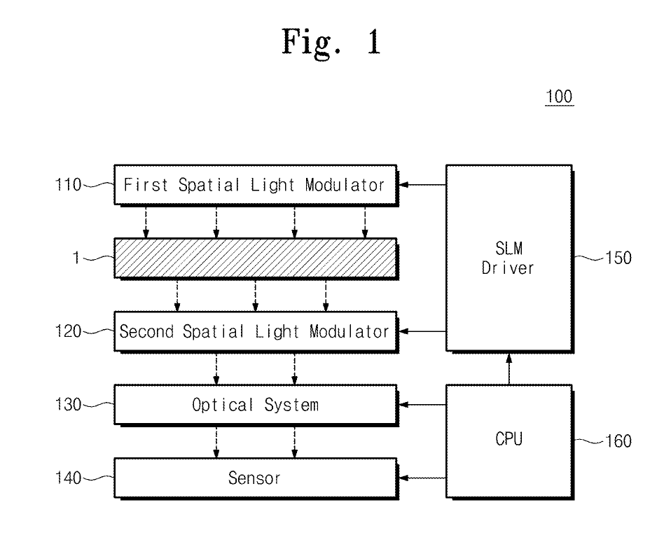

FIG. 1 is a block diagram schematically illustrating a biochip analysis device according to an embodiment of the inventive concept. Referring to FIG. 1, a biochip analysis device 100 may include a first spatial light modulator 110, a second spatial light modulator 120, an optical system 130, a sensor 140, a spatial light modulation driver (hereinafter, referred to as SLM driver) 150, and a central processing unit 160.

With the biochip analysis device 100, a biochip 1 may be located between the first spatial light modulator 110 and the second spatial light modulator 120, and a wavelength radiated to the biochip 1 and a wavelength of a fluorescence signal generated from the biochip 1 may be varied through the first and second spatial light modulators 110 and 120 according to a property of the biochip 1 to be analyzed.

The first spatial light modulator 110 may be located over the biochip 1 to be analyzed. The first spatial light modulator 110 may output light of the same wavelength as an absorption wavelength range of a fluorescence substance located on the biochip 1. That is, the first spatial light modulator 110 may irradiate light to the biochip 1, and may vary a wavelength of light irradiated to the biochip 1 in response to the control of the SLM driver 150 so as to correspond to an absorption band of the fluorescence substance of the biochip 1.

The second spatial light modulator 120 may be located below the biochip 1 to be analyzed. The second spatial light modulator 120 may select a predetermined fluorescence signal of fluorescence signals generated from the fluorescence substance of the biochip 1. That is, if the fluorescence substance of the biochip 1 generates a fluorescence signal according to light irradiated from the first spatial light modulator 110, the second spatial light modulator 120 may pass a fluorescence signal having a predetermined wavelength in response to the control of the SLM driver 150.

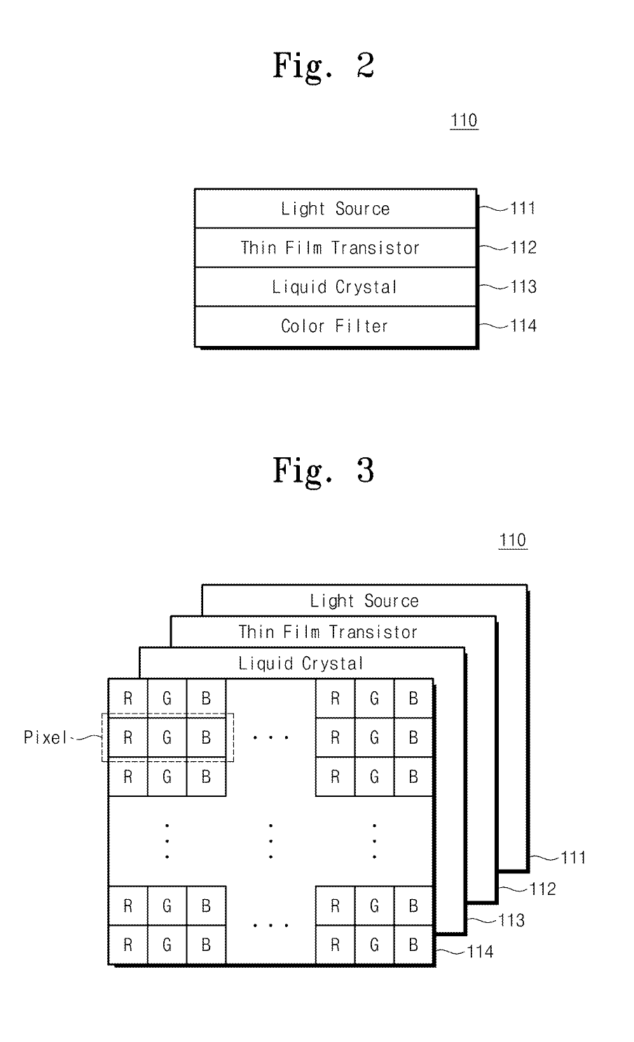

The first spatial light modulator 110 and the second spatial light modulator 120 may be integrated with a color filter, a liquid crystal, and the like without separate mechanical components. The first spatial light modulator 110 and the second spatial light modulator 120 will be more fully described with reference to FIGS. 2 and 3.

The optical system 130 may receive light (or, a fluorescence signal having a predetermined wavelength) penetrating the second spatial light modulator 120 to perform reflecting and refracting on the input light. The sensor 140 may receive light (or, a fluorescence signal having a predetermined wavelength) from the optical system 130. Herein, the sensor 140, for example, may be formed of an image sensor such as CCD, CMOS, and the like. Alternatively, the sensor 140 may be formed of a detector such as a photodiode array, a photodiode, or the like.

The SLM driver 150 may control the first spatial light modulator 110 and the second spatial light modulator 120, and the central processing unit 160 may analyze the biochip 1 by analyzing and processing information associated with light (or, a fluorescence signal having a predetermined wavelength) reaching the sensor 140.

As described with reference to FIG. 1, the biochip analysis device 100 may vary a wavelength of light irradiated to a biochip 1 according to a property of the biochip to be analyzed. If the fluorescence substance of the biochip 1 generates a fluorescence signal according to light irradiated from the first spatial light modulator 110, the biochip analysis device 100 may selectively pass a fluorescence signal to be analyzed to analyze it.

In this case, the first spatial light modulator 110 and the second spatial light modulator 120 may be implemented by one module without separate mechanical components. Thus, it is possible to miniaturize the biochip analysis device 100. Below, the first spatial light modulator 110 and the second spatial light modulator 120 will be more fully described.

FIGS. 2 and 3 are diagrams schematically illustrating a first spatial light modulator 110 in FIG. 1.

Referring to FIG. 2, a first spatial light modulator 110 may include a light source 111, a thin film transistor 112, a liquid crystal 113, and a color filter 114. The first spatial light modulator 110 may have such as structure that the light source 111, the thin film transistor 112, the liquid crystal 113, and the color filter 114 are integrated without separate mechanical components.

The light source 111 may generate while light and have a planar shape. However, the inventive concept is not limited thereto. The light source 111 can be formed to have a backlight shape.

The thin film transistor 112 may be driven under the control of an SLM driver 150 (refer to FIG. 1). The thin film transistor 112 may include a plurality of sub transistors (not shown) corresponding to a channel, and the plurality of sub transistors may be driven under the control of the SLM driver 150. For example, a voltage between 0V to 15V may be applied to a gate of a sub transistor. For example, the sub transistor may be turned off when a voltage of 0V is applied to the gate of the sub transistor, and may be turned on when a voltage of 15V is applied to the gate of the sub transistor.

The color filter 114 may be formed by coating pigment or dielectric on the liquid crystal 113. The color filter 114, the liquid crystal 113, the thin film transistor 112, and the light source 111 may be fabricated according to a TFT-LCD fabricating method. Thus, the first spatial light modulator 110 may be formed of one module without separate mechanical components.

Referring to FIG. 3, the color filter 114 may include a red channel R, a green channel G, and a blue channel B. The three channels R, G, and B may constitute one pixel. That is, the color filter 114 may have an array structure in which one pixel is formed of three channels R, G, and B.

A channel region and a sub thin film transistor corresponding to each channel of the color filter 114 may exist at the liquid crystal 113 and the thin film transistor 112. Thus, the SLM driver 150 may control a sub thin film transistor corresponding to each channel of the color filter 114 such that light, having a wavelength corresponding to each channel, from among the white light generated from the light source 111 is selectively irradiated to a biochip 1 (refer to FIG. 1).

In the event that light of a wavelength corresponding to the red channel R is output to the biochip 1, the SLM driver 150 may selectively control a sub thin film transistor of a thin film transistor 112 corresponding to the red channel R of the color filter 114. Thus, light of a wavelength corresponding to the red channel R may be provided to the biochip 1.

Further, in the event that light of a wavelength corresponding to a combination of the three channels R, G, and B is output to the biochip 1, the SLM driver 150 may selectively control sub thin film transistors corresponding to the three channels R, G, and B of the color filter 114 such that light of a desired wavelength is irradiated to the biochip 1.

As described above, the first spatial light modulator 110 may irradiate light of a desired wavelength to a biochip by controlling light passing through three channels of the color filter 114. Also, since the color filter 114 of the first spatial light modulator 110 is configured such that patterned channels are arranged, the first spatial light modulator 110 may be useful to analyze an optical property of a biochip formed by an array shape. In the event that a biochip includes fluorescence substances having different wavelengths, the first spatial light modulator 110 may analyze an optical property of a biochip easily and rapidly by sequentially operating sub thin film transistors corresponding to channels, respectively.

Likewise, a second light modulator 120 (refer to FIG. 1) may be configured to be analogous to the first spatial light modulator 110. For example, the second light modulator 120 may be formed to include a thin film transistor, a liquid crystal, and a color filter other than a light source. Also, the second light modulator 120 may control sub thin film transistors corresponding to channels of a color filter such that light of a desired wavelength of a fluorescence signal generated from a biochip is penetrated. The second light modulator 120 may be analogous to a first light modulator 110 in operation and configuration, and description thereof is thus omitted.

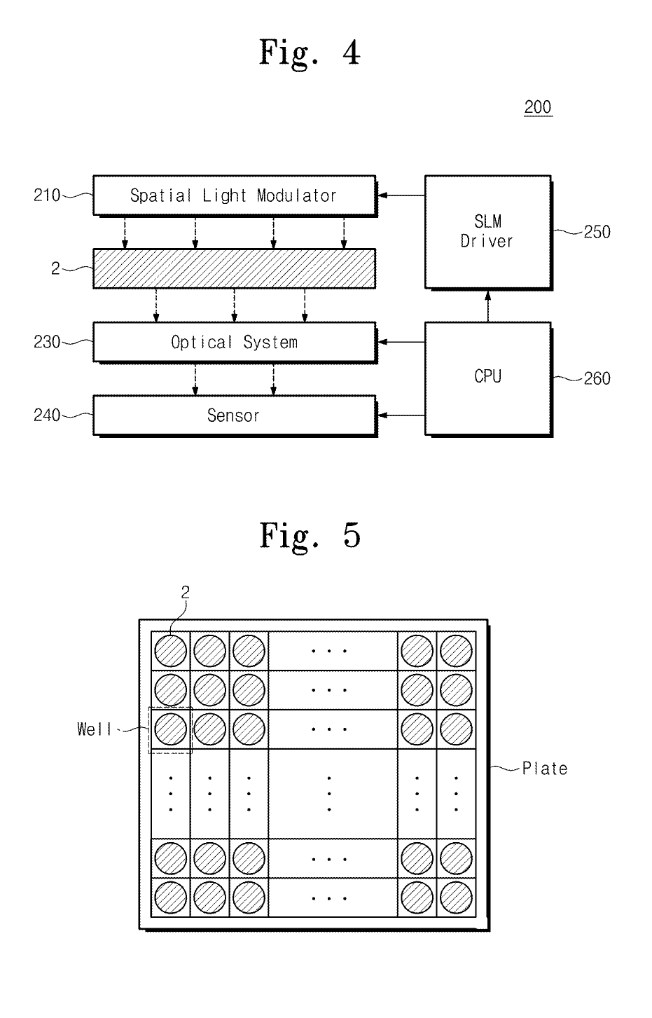

FIGS. 4 and 5 are diagrams schematically illustrating a biochip analysis device according to another embodiment of the inventive concept. A biochip analysis device 200 in FIGS. 4 and 5 may be used to measure absorbance of a biochip. The biochip analysis device 200 in FIGS. 4 and 5 may be analogous to that in FIG. 1. Thus, a difference between the biochip analysis devices 100 and 200 will be mainly described.

Referring to FIG. 4, the biochip analysis device 200 may include a spatial light modulator 210, an optical system 230, a sensor 240, an SLM driver 250, and a central processing unit 260.

The biochip analysis device 200 may be used to measure absorbance of a biochip 2. Thus, the biochip analysis device 200 need not necessitate a device for passing through a fluorescence signal generated from the biochip 2. Unlike a biochip analysis device 100 in FIG. 1, the biochip analysis device 200 may include only one spatial light modulator 210.

The biochip analysis device 200 may be configured to process many biochips at a time. For example, as illustrated in FIG. 5, a plate on which the biochip 2 is put may be formed by an array shape which includes a plurality of wells to receive a plurality of biochips. In this case, one well may be designed to correspond to one channel or one pixel of a color filter. Thus, the biochip analysis device 200 may measure and analyze an optical absorption property on a plurality of biochips at a time.

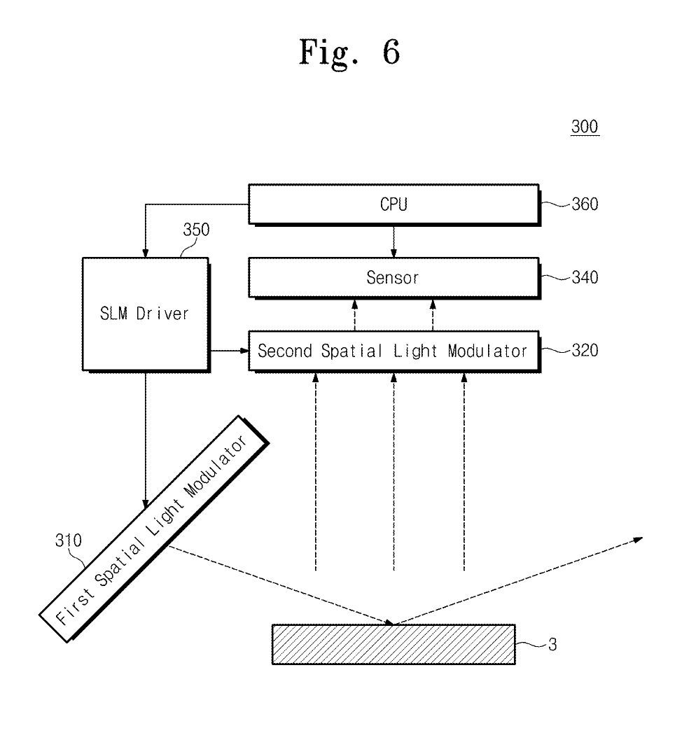

FIG. 6 is a diagram schematically illustrating a biochip analysis device according to still another embodiment of the inventive concept. A biochip analysis device 300 in FIG. 6 may be analogous to that in FIG. 1. Thus, a difference between the biochip analysis devices 100 and 300 will be mainly described.

Referring to FIG. 6, the biochip analysis device 300 may include a first spatial light modulator 310, a second spatial light modulator 320, a sensor 340, an SLM driver 450, and a central processing unit 660. Unlike a biochip analysis device 100 in FIG. 1, the biochip analysis device 300 may irradiate light of a desired wavelength to a biochip 3 with a predetermined tilt angle.

In this case, the biochip analysis device 300 may measure a fluorescence signal, generated in a direction perpendicular to a surface of a biochip 3, from among fluorescence signals generated from the biochip 3. The fluorescence signal generated in a direction perpendicular to a surface of the biochip 3 may reach the sensor 340 through the second spatial light modulator 320. The central processing unit 360 may analyze a property of the biochip 3 by analyzing a fluorescence signal reaching the sensor 340.

The second spatial light modulator 320 may be configured to have the same structure as a second spatial light modulator 120 in FIG. 2. The second spatial light modulator 320 can be configured to include only a color filter to only filter a fluorescence signal.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A biochip analysis device comprising:
first and second spatial light modulators; and
a spatial light modulation driver configured to drive the first and second spatial light modulators,
wherein the first spatial light modulator varies a wavelength of light to be irradiated to a biochip in response to a control of the spatial light modulation driver and the second spatial light modulator passes a fluorescence signal selected from fluorescence signals generated by the biochip in response to a control of the spatial light modulation driver.

2. The biochip analysis device of claim 1, wherein the first spatial light modulator comprises:
a liquid crystal;
a color filter formed on the liquid crystal; and
a thin film transistor controlling light to be provided to the color filter,
wherein the first spatial light modulator varies a wavelength of light to be irradiated to the biochip by turning off or on the thin film transistor.

3. The biochip analysis device of claim 2, wherein the color filter has an array structure in which one pixel is formed of a red channel, a green channel, and a blue channel.

4. The biochip analysis device of claim 3, wherein the first spatial light modulator varies a wavelength of light to be irradiated to the biochip by combining light passing through the red, green, and blue channels.

5. The biochip analysis device of claim 2, wherein the first spatial light modulator further comprises a light source which generates white light, and wherein the light source, the liquid crystal, the color filter, and the thin film transistor being formed of one module.

6. The biochip analysis device of claim 2, wherein the color filter is formed of a pigment or dielectric thin film.

7. The biochip analysis device of claim 1, wherein the first spatial light modulator varies a wavelength of light to be irradiated to the biochip so as to correspond to an absorption wavelength band of a fluorescence substance of the biochip.

8. The biochip analysis device of claim 1, wherein the second spatial light modulator comprises:
a liquid crystal;
a color filter formed on the liquid crystal; and
a thin film transistor controlling light to be provided to the color filter,
wherein the second spatial light modulator passes through a fluorescence signal of a selected wavelength from among fluorescence signals generated from the biochip by turning off or on the thin film transistor.

9. The biochip analysis device of claim 8, wherein the liquid crystal, the color filter, and the thin film transistor is formed of one module.

10. The biochip analysis device of claim 1, further comprising:
a sensor receiving a fluorescence signal passing through the second spatial light modulator; and
a central processing unit analyzing a fluorescence signal reaching the sensor to judge a property of the biochip.

11. The biochip analysis device of claim 1, wherein the first spatial light modulator irradiates light to the biochip with a predetermined tilt angle and the second spatial light modulator passes through a fluorescence signal, having a direction perpendicular to the biochip, from among fluorescence signals generated form the biochip.

12. A biochip analysis device comprising:
a spatial light modulator; and
a spatial light modulation driver driving the spatial light modulator,
wherein the spatial light modulator analyzes an optical absorption property of the biochip by varying a wavelength of light to be irradiated to the biochip in response to a control of the spatial light modulation driver.

13. The biochip analysis device of claim 12, wherein the spatial light modulator includes a plate receiving the biochip, the plate being formed to have an array structure which includes a plurality of wells receiving a plurality of biochip samples, respectively.

14. The biochip analysis device of claim 13, wherein the spatial light modulator further includes a color filter, the plurality of wells corresponding to channels or pixels of the color filter, respectively.

15. The biochip analysis device of claim 13, wherein the spatial light modulator further comprises:
a liquid crystal;
a color filter formed on the liquid crystal; and
a thin film transistor controlling light to be provided to the color filter,
wherein the color filter has an array structure in which one pixel is formed of a red channel, a green channel, and a blue channel and the thin film transistor varies a wavelength of light to be irradiated to the biochip by turning on or off sub transistors corresponding to the red, green, and blue channels, respectively.
